(19) United States
(12) Patent Application Publication
(10) Pub. No.: US 2012/0161044 A1
(43) Pub. Date: Jun. 28, 2012

(54) VACUUM VALVE

(76) Inventor: Hsin-Yu CHEN, Taichung Hsien (TW)

(21) Appl. No.: 12/980,121

(22) Filed: Dec. 28, 2010

(51) Int. Cl. F16K 7/17; F16K 31/145; F16K 31/126

(52) U.S. Cl. 251/61.1; 251/331

(57) ABSTRACT

A vacuum valve installed on an opening of a sealed container includes an air-resistance membrane, a valve and at least one airflow passage. The valve is latched on the opening. The airflow passage runs through the valve and communicates with the sealed container. The air-resistance membrane is mounted onto the valve and has an annular flange to surround and seal the airflow passage. The protrusive annular flange is deformable to form an airtight structure to maintain a vacuum condition in the sealed container for a prolonged duration to meet use requirements.

### FIELD OF THE INVENTION

The present invention relates to a vacuum preservation apparatus and particularly to a vacuum valve adopted for a sealed container.

### BACKGROUND OF THE INVENTION

Please refer to FIGS. 1 and 2, a conventional sealed container 1 includes an air valve 2 located thereon. Through an air extraction device 3, air in the sealed container 1 is extracted via an airflow passage 4. The air valve 2 covers the surface of the sealed container 1 and seals the airflow passage 4 to maintain a vacuum condition in the sealed container 1 to keep food fresh inside. As the external pressure outside the sealed container 1 is greater than the internal pressure, a butting force 5 is generated to press the air valve 2 to seal the airflow passage 4 to isolate air and maintain the vacuum condition inside the sealed container 1.

Referring to FIG. 3, due to the sealed container 1 generally is made of plastics through an injection process in a hard shell fashion, any defect caused during the injection process could form uneven surface on the sealed container 1 and result in uneven covering of the air valve 2 on the sealed container 1, and slight gaps 6 could be formed between the air valve 2 and the sealed container 1. Hence the airflow passage 4 cannot be fully sealed to maintain a desired vacuum condition in the sealed container 1. Even air 7 could continuously permeate into and make maintaining the vacuum condition in the sealed container 1 impossible.

As a result, when injection defects occur during production of the sealed container 1, the sealed container 1 becomes a defective product and has to be discarded. To improve production yield of the sealed container 1, fabrication conditions of the injection process have to be advanced, but the cost is also increased. Moreover, there are always some finished products of the sealed containers 1 having uneven surfaces which does not meet requirements.

Refer to FIG. 4 for another type of the conventional sealed container 1A. It is made of pliable material and can be shrunk to meet the size of a preserved object 8. It occupies smaller space and provides greater usability. However, after the air has been extracted from the sealed container 1A, the pressures at two sides of the air valve 2A are almost equal, hence there is no adequate butting force applying on the air valve 2A to form tight sealing of the air suction vent 9 of the sealed container 1A. Air isolation effect of the air valve 2A suffers, and air leakage takes place slowly and constantly.

In short, the conventional air valve 2 requires greater surface smoothness on the sealed container 1, this makes maintaining the vacuum condition of the sealed container 1 more difficult to meet use requirements. On the other hand, the air valve 2A is not suitable for the pliable sealed container 1A.

### SUMMARY OF THE INVENTION

Therefore, the primary object of the present invention is to provide a vacuum valve to maintain a desired vacuum condition to meet use requirements.

The vacuum valve according to the invention is installed on an opening of a sealed container, and includes an air-resistance membrane, a valve and at least one airflow passage. The valve is latched on the opening. The airflow passage runs through the valve and communicates with the sealed container. The air-resistance membrane is mounted onto the valve and has an annular flange to surround and seal the airflow passage.

When the sealed container is formed in a vacuum condition, as the annular flange surrounds and seals the airflow passage, the protrusive annular flange can be deformed to form a tight air blocking effect. Hence the airtight condition of the sealed container can be maintained for a prolonged duration to meet use requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional sealed container equipped with an air valve in a vacuuming condition.

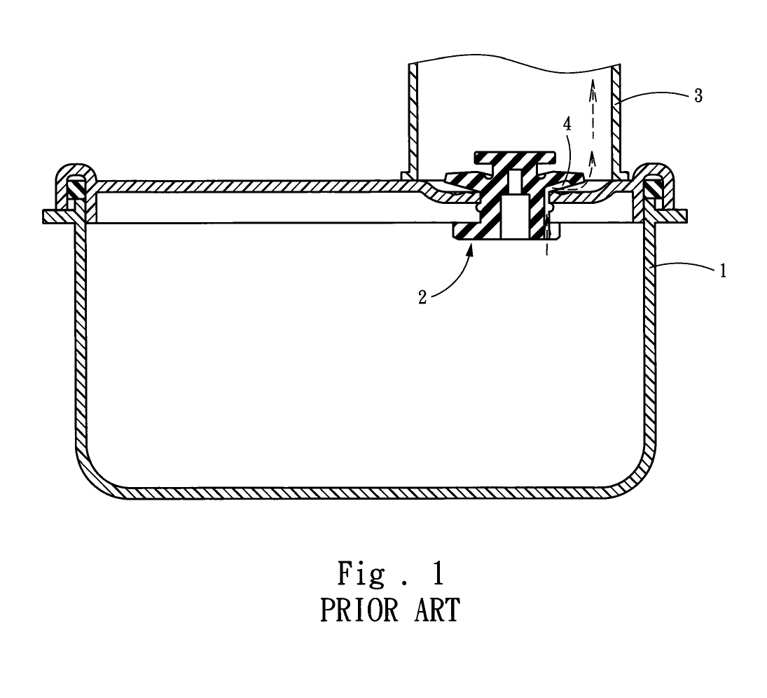

FIG. 2 is a schematic view of a conventional sealed container equipped with an air valve in maintaining a vacuum condition.

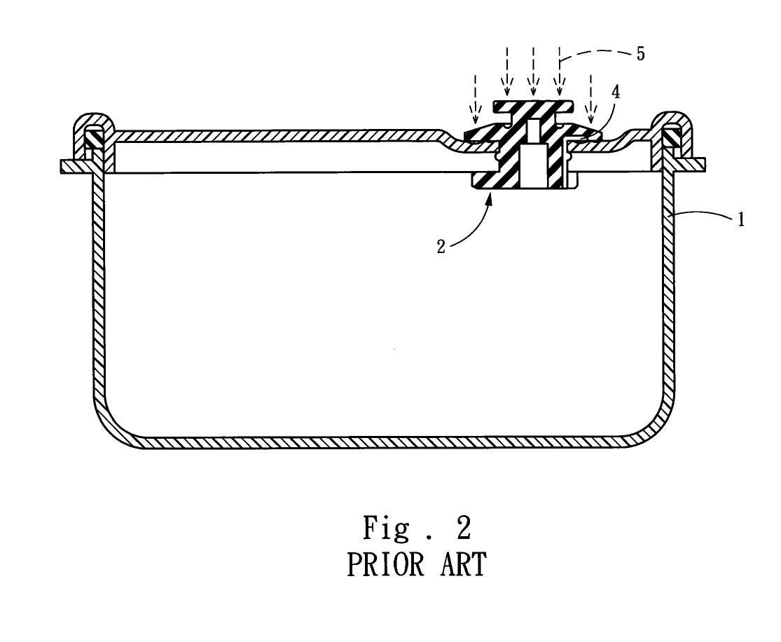

FIG. 3 is a schematic view of a conventional air valve in an air leakage condition.

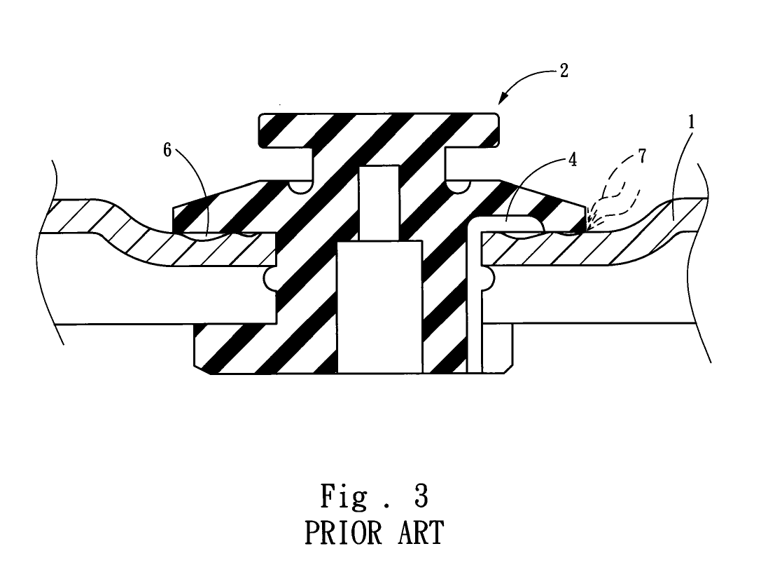

FIG. 4 is a schematic view of another conventional air valve in maintaining a vacuum condition.

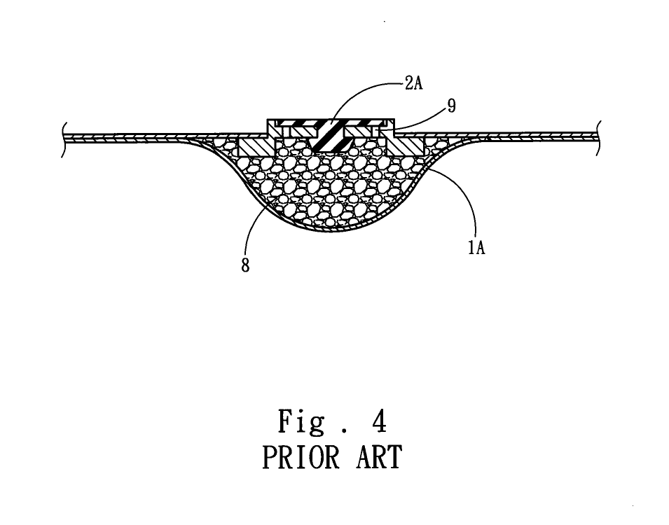

FIG. 5 is a perspective view of a first embodiment of the vacuum valve of the invention.

FIG. 6 is another perspective view of the first embodiment of the vacuum valve of the invention.

FIG. 7 is a schematic view of the first embodiment of the vacuum valve of the invention in an installation condition.

FIG. 8 is a schematic view of the first embodiment of the vacuum valve of the invention in a use condition.

FIG. 9 is a schematic view of the first embodiment of the vacuum valve of the invention in maintaining a vacuum condition.

FIG. 10 is a schematic view of the first embodiment of the vacuum valve of the invention in an air blocking condition.

FIG. 11 is a perspective view of a second embodiment of the vacuum valve of the invention.

FIG. 12 is a schematic view of the second embodiment of the vacuum valve of the invention in an installation condition.

FIG. 13 is a schematic view of the second embodiment of the vacuum valve of the invention in a use condition.

FIG. 14 is a schematic view of the second embodiment of the vacuum valve of the invention in maintaining a vacuum condition.

### DETAILED DESCRIPTION OF THE PREFERRED EMBODIMENTS

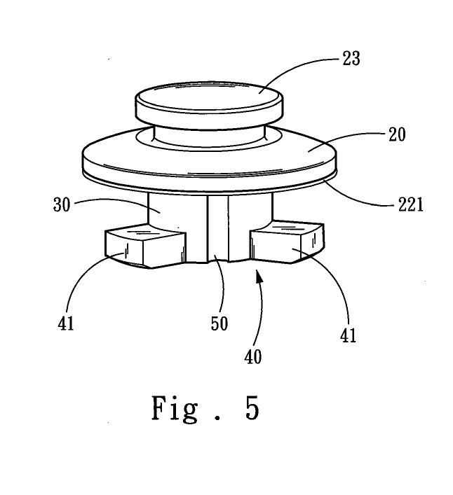

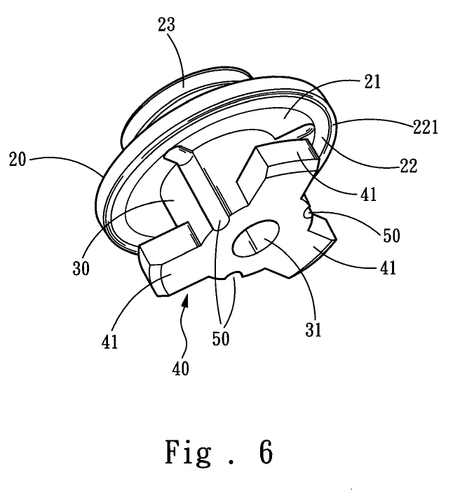

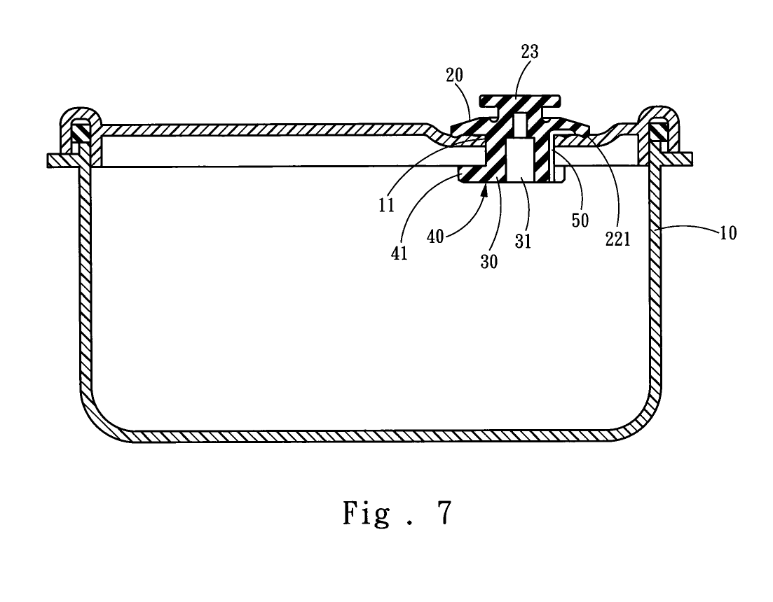

Refer to FIGS. 5, 6 and 7 for a first embodiment of the vacuum valve of the invention. The vacuum valve is installed on an opening 11 of a sealed container 10, and includes an air-resistance membrane 20, a valve 30, a detent portion 40 and at least one airflow passage 50. The air-resistance membrane 20 has an inner rim 21 and an outer rim 22 and a jutting knob 23 in the center extended upwards. The valve 30 has a central hole 31 extended to the bottom thereof.

The valve 30 is latched on the opening 11. The detent portion 40 is attached to the inner periphery surface of the opening 11 of the sealed container 10, and has three detent lugs 41 extended outwards to butt the sealed container 10. The air-resistance membrane 20 presses the sealed container 10. The airflow passage 50 can be formed in three sets on the periphery of the valve 30 and extended to the inner rim 21 of the air-resistance membrane 20. The outer rim 22 has an annular flange 221 surrounding the opening 11 and tightly butting the sealed container 10.

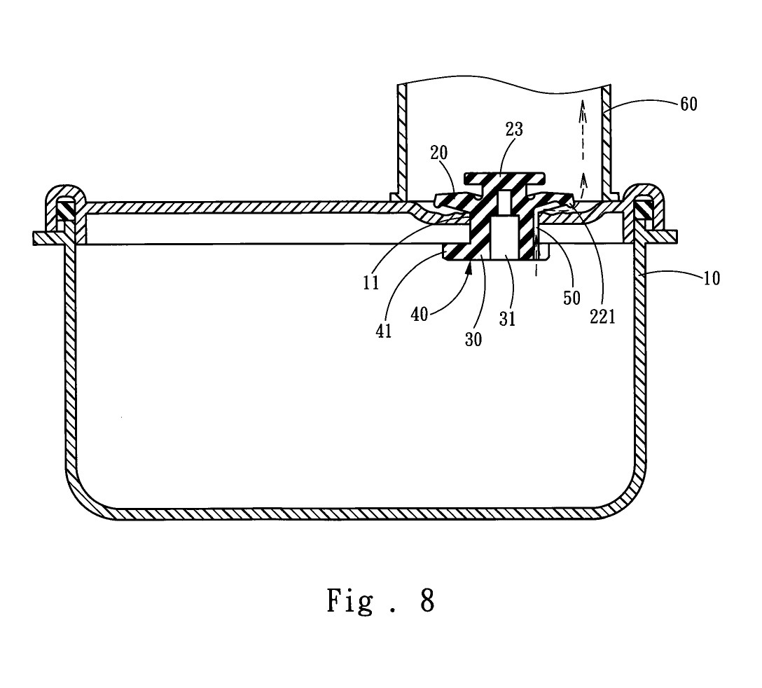

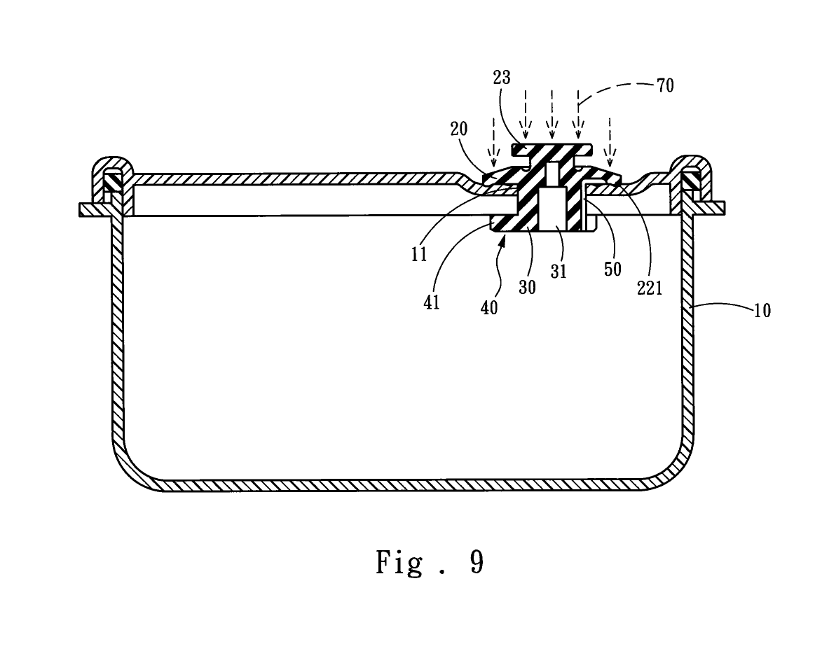

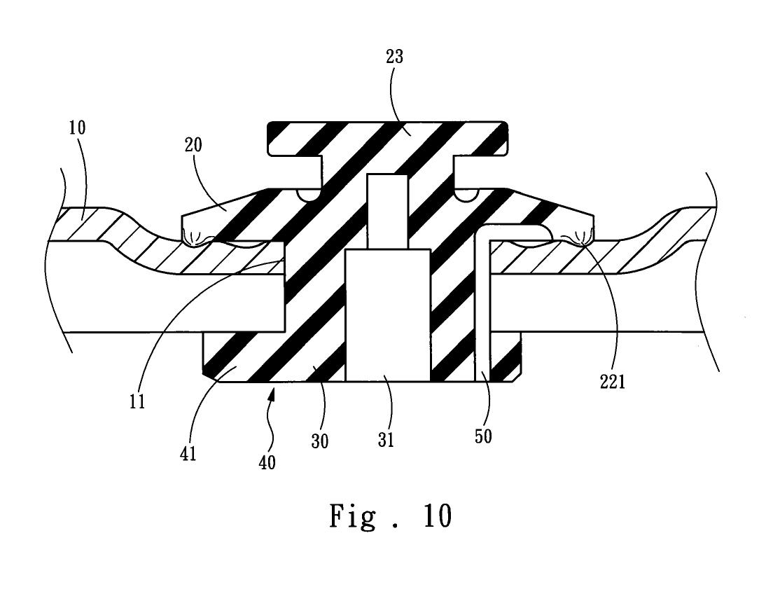

Refer to FIGS. 8, 9 and 10 for the first embodiment in use conditions by incorporating with an air suction device 60. The air suction device 60 covers the air-resistance membrane 20 and extracts air to generate a pressure difference to flip the outer rim 22 outwards to expose the airflow passage 50, and then air inside the sealed container 10 is extracted through the airflow passage 50 to form a vacuum condition inside the sealed container 10. When the air suction device 60 stops air extraction operation, the air-resistance membrane 20 covers the opening 11 and a butting force 70 is generated by the atmospheric pressure to compress the annular flange 221 to be deformed to tightly butt the periphery of the opening 11. Thus even if the periphery surface of the opening 11 is uneven, the deformed annular flange 221 can fill the uneven surface to form an airtight structure to maintain the vacuum condition in the sealed container 10 for a prolonged duration to meet use requirements.

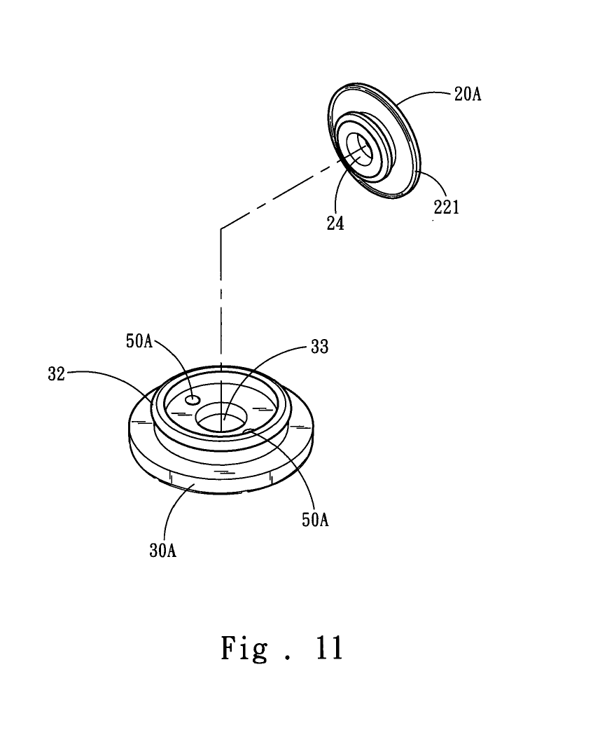

Please refer to FIG. 11 for a second embodiment of the invention. The valve 30A has an inverse hook portion 32 on the periphery and a latch hole 33 in the center. The air-resistance membrane 20A has a strut 24 mating the latch hole 33 to be latch therein, such that the air-resistance membrane 20A can be securely mounted onto the valve 30A. The airflow passage 50A can be formed in two sets located at two sides of the latch hole 33. The annular flange 221 surrounds the periphery of the air-resistance membrane 20A.

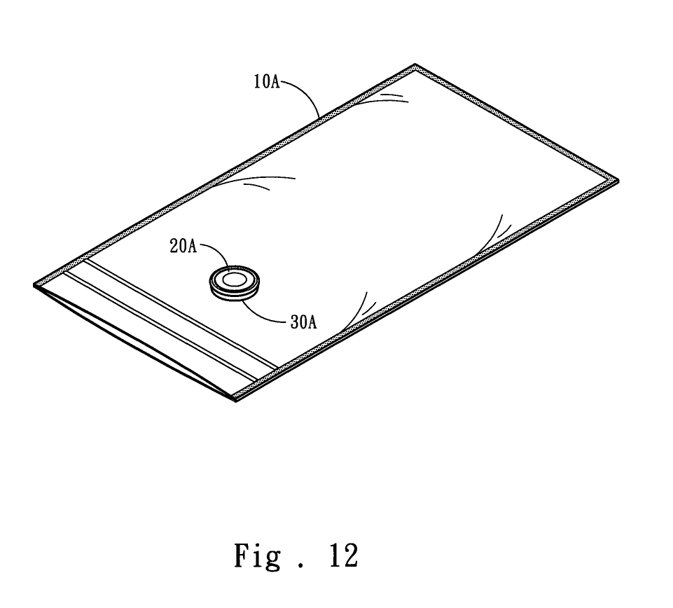

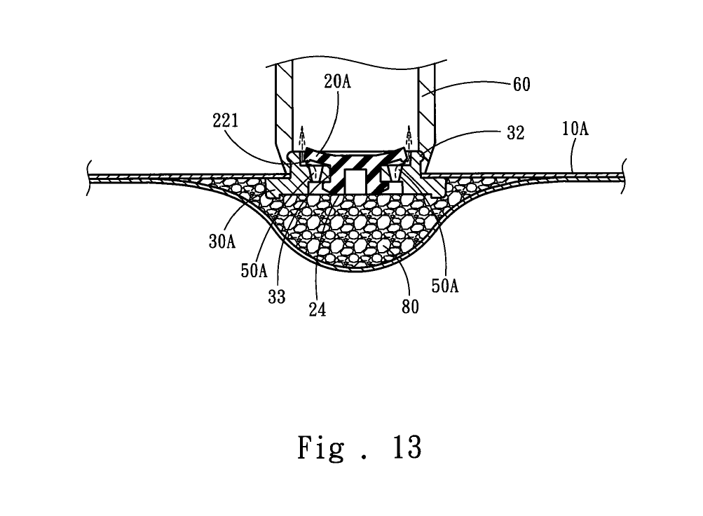

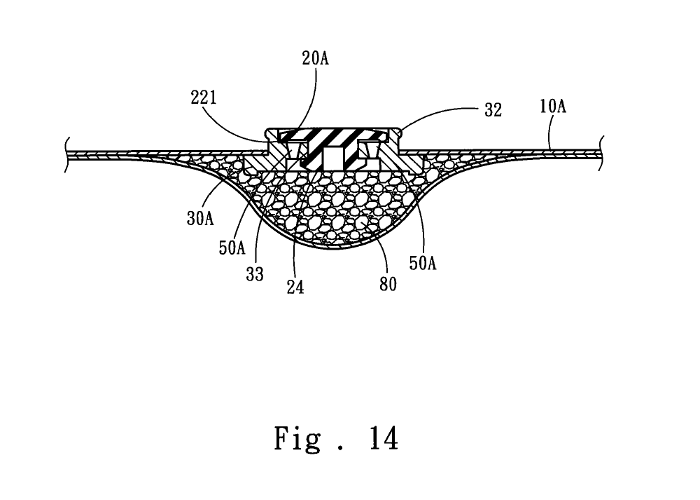

Referring to FIGS. 12, 13 and 14, the inverse hook portion 32 can hold the air suction device 60 in various angles to improve usability. The sealed container 10A is made of a pliable material and holds a preserved object 80. With the air suction device 60 latched by the inverse hook portion 32 to extract air from the sealed container 10A, the sealed container 10A is free of air and the preserved object 80 held therein is less likely to be spoiled. As there is no pressure difference between the interior and exterior of the sealed container 10A, compressive force is absent. However, as the annular flange 221 located on the air-resistance membrane 20A, the air-resistance membrane 20A is deformable to generate a restoring force to form a tight contact with the valve 30A to seal the airflow passage 50A, thus a desired airtight condition can be achieved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A vacuum valve installed on an opening of a sealed container, comprising:
a valve latched on the opening;
at least one airflow passage running through the valve and communicating with the sealed container; and
an air-resistance membrane which is mounted onto the valve and includes an annular flange to surround and seal the airflow passage.

2. The vacuum valve of claim 1, wherein the air-resistance membrane includes an inner rim and an outer rim and presses the sealed container, the airflow passage being formed on the periphery of the valve and extended to the inner rim of the air-resistance membrane, the outer rim including the annular flange to surround the opening and tightly press the sealed container.

3. The vacuum valve of claim 2, wherein the air-resistance membrane includes a jutting knob in the center extended upwards, the valve including a central hole extended to the bottom thereof.

4. The vacuum valve of claim 2, wherein the airflow passage includes three sets distributed on the periphery of the valve.

5. The vacuum valve of claim 1 further comprising a detent portion attached to an inner periphery surface of the opening of the sealed container.

6. The vacuum valve of claim 5, wherein the detent portion includes three detent lugs extended outwards to press the sealed container.

7. The vacuum valve of claim 1, wherein the valve includes an inverse hook portion on the periphery thereof.

8. The vacuum valve of claim 1, wherein the valve includes a latch hole in the center, the air-resistance membrane including a strut mating and latching the latch hole to allow the air-resistance membrane to be mounted onto the valve.

9. The vacuum valve of claim 8, wherein the airflow passage includes two sets located at two sides of the latch hole.

10. The vacuum valve of claim 9, wherein the annular flange surrounds the periphery of the air-resistance membrane.
